(19) United States
(12) Patent Application Publication
(10) Pub. No.: US 2025/0212286 A1
(43) Pub. Date: Jun. 26, 2025

(54) CENTRAL UNIT CONTROL PLANE APPARATUS, CENTRAL UNIT USER PLANE APPARATUS, AND METHODS THREFOR

(71) Applicant: NEC Corporation, Minato-ku, Tokyo (JP)

(72) Inventors: Daiki MIHARA, Tokyo (JP); Kenji KAI, Tokyo (JP); Sadafuku HAYASHI, Tokyo (JP)

(73) Assignee: NEC Corporation, Minato-ku, Tokyo (JP)

(21) Appl. No.: 18/847,901

(22) PCT Filed: Feb. 8, 2023
(86) PCT No.: PCT/JP2023/004100

§ 371 Date: Sep. 17, 2024

(30) Foreign Application Priority Data
Mar. 30, 2022 (JP) 2022-054841

(51) Int. Cl. H04W 76/22; H04W 76/12; H04W 76/32; H04W 92/16

(52) U.S. Cl. CPC H04W 76/22; H04W 76/12; H04W 76/32; H04W 92/16

(57) ABSTRACT

An apparatus configured to operate as a central unit control plane (21) of a radio access network node (1) sends to a central unit user plane (22) of the radio access network node (1) a single control message indicating that one or more Packet Data Convergence Protocol (PDCP) count values for an Acknowledged Mode (AM) data radio bearer (DRB) already configured for a radio terminal (4) need to be reset. This can help, for example, to facilitate the resetting of a PDCP count value for an AM DRB by a radio access network node using an architecture in which its control plane and user plane are separated.

### TECHNICAL FIELD

The present disclosure relates to a radio communication system, in particular to an interface between a central unit control plane and a central unit user plane.

### BACKGROUND ART

The 3rd Generation Partnership Project (3GPP (registered trademark)) provides specifications for the Fifth Generation System (5GS), including the NG Radio Access Network (NG-RAN) architecture and signaling protocols. Non-Patent Literature 1 specifies the 5G radio network layer signaling protocol for the E1 interface, namely the E1 Application Protocol (E1AP). The E1 interface provides a means of interconnecting a gNB Central Unit Control Plane (CU-CP) and a gNB Central Unit User Plane (CU-UP) of a gNB in the NG-RAN. Alternatively, the E1 interface provides a means of interconnecting a gNB-CU-CP and a gNB-CU-UP of an en-gNB in the Evolved Universal Mobile Telecommunications System (UMTS) Terrestrial Radio Access Network (E-UTRAN).

A gNB is a node that provides NR user plane and control plane protocol terminations to a User Equipment (UE) and is connected to a 5G Core Network (5GC) via the NG interface. On the other hand, an en-gNB is a node that provides NR user plane and control plane protocol terminations to a UE and acts as a secondary node for E-UTRA-NR Dual Connectivity (EN-DC).

A gNB-CU is a logical node that hosts the Radio Resource Control (RRC), Service Data Adaptation Protocol (SDAP) and Packet Data Convergence Protocol (PDCP) protocols of the gNB, or the RRC and PDCP protocols of the en-gNB, and controls the operation of one or more gNB Distributed Units (DUs). A gNB-CU terminates the F1 interface connected with a gNB-DU. A gNB-DU is a logical node that hosts the Radio Link Control (RLC), Medium Access Control (MAC) and Physical (PHY) layers of the gNB or the en-gNB, and its operation is partially controlled by the gNB-CU. One gNB-DU supports one or more cells. One cell is supported by only one gNB-DU. A gNB-DU terminates the F1 interface connected with the gNB-CU.

A gNB-CU-CP is a logical node that hosts the RRC and the control plane part of the PDCP protocol of the gNB-CU for an en-gNB or a gNB. A gNB-CU-CP terminates the E1 interface connected with a gNB-CU-UP and the F1-C interface connected with a gNB-DU.

A gNB-CU-UP is a logical node that hosts the user plane part of the PDCP protocol of the gNB-CU for an en-gNB or hosts the user plane part of the PDCP protocol and the SDAP protocol of the gNB-CU for a gNB. A gNB-CU-UP terminates the E1 interface connected with the gNB-CU-CP and the F1-U interface connected with a gNB-DU.

According to Non-Patent Literature 1, a gNB-CU-CP may request a gNB-CU-UP to perform a Packet Data Convergence Protocol (PDCP) re-establishment with respect to one or more Data Radio Bearers (DRBs) already configured for a UE via a BEARER CONTEXT MODIFICATION REQUEST message. Specifically, the BEARER CONTEXT MODIFICATION REQUEST message may include a PDU Session Resource To Modify List IE. The PDU Session Resource To Modify List IE may include a DRB To Modify List IE. The DRB To Modify List IE includes a PDCP Configuration IE for each of the one or more DRBs to be modified. The PDCP Configuration IE may include a PDCP Re-establishment IE. The PDCP Re-establishment IE indicates that the re-establishment of the PDCP entity is triggered as defined in 3GPP TS 38.323 (Non-Patent Literature 2).

According to Section 5.1.2 of Non-Patent Literature 2, in a PDCP re-establishment, the transmitting PDCP entity sets TX_NEXT to the initial value for Unacknowledged Mode (UM) DRBs and Signalling Radio Bearers (SRBs). Similarly, in a PDCP Re-establishment, the receiving PDCP entity sets RX_NEXT to the initial value for UM DRBs and SRBs. TX_NEXT is a state variable that indicates the COUNT value of the next PDCP Service Data Unit (SDU) to be transmitted. The initial value of TX_NEXT for DRBs is 0. RX_NEXT is a state variable that indicates the COUNT value of the next PDCP SDU expected to be received. The initial value of RX_NEXT for DRBs of the Uu interface between a UE and a gNB is 0. The COUNT value is composed of a Hyper Frame Number (HFN) and a PDCP Sequence Number (SN).

### CITATION LIST

### Non Patent Literature

[Non-Patent Literature 1] 3GPP TS 38.463 V16.8.0 (2021-12) “3rd Generation Partnership Project: Technical Specification Group Radio Access Network: NG-RAN: E1 Application Protocol (E1AP) (Release 16)”, December 2021
[Non-Patent Literature 2] 3GPP TS 38.323 V16.6.0 (2021-12) “3rd Generation Partnership Project: Technical Specification Group Radio Access Network: NR: Packet Data Convergence Protocol (PDCP) specification (Release 16)”, December 2021

### SUMMARY OF INVENTION

### Technical Problem

It is not clear how a gNB-CU-CP instructs a gNB-CU-UP to reset PDCP counts for one or more DRBs already configured for a UE, using, for example, a BEARER CONTEXT MODIFICATION REQUEST message. These DRBs include Acknowledged Mode (AM) DRBs.

As described above, according to the provisions of Non-Patent Literature 1, the gNB-CU-CP may instruct the gNB-CU-UP to perform PDCP re-establishment for a DRB by including a PDCP Re-establishment IE in a BEARER CONTEXT MODIFICATION REQUEST message. According to the provisions of Non-Patent Literature 2, for UM DRBs, a PDCP re-establishment involves resetting the PDCP count values, i.e., setting the PDCP count values to their initial values. A UM DRB is a data radio bearer that uses Unacknowledged Mode (UM) RLC. In other words, a UM DRB is a DRB for which Unacknowledged Mode (UM) is used in the RLC sublayer.

However, the gNB-CU-CP cannot instruct (or request) the gNB-CU-UP to reset the PDCP count values for AM DRBs by a single control message (i.e., E1AP message). An AM DRB is a data radio bearer that uses Acknowledged Mode (AM) Radio Link Control (RLC). In other words, an AM DRB is a DRB for which Acknowledged Mode (AM) is used in the RLC sublayer.

As a possible approach, the gNB-CU-CP can send a first BEARER CONTEXT MODIFICATION REQUEST message to the gNB-CU-UP requesting the release of an AM DRB, and then send a second BEARER CONTEXT MODIFICATION REQUEST message to the gNB-CU-UP requesting the re-setup of this AM DRB. The gNB-CU-UP releases the PDCP entity of the AM DRB in response to the first BEARER CONTEXT MODIFICATION REQUEST message, and then establishes the PDCP entity of the AM DRB again in response to the second BEARER CONTEXT MODIFICATION REQUEST message. Establishing the PDCP entity involves setting the state variables, including TX_NEXT and RX_NEXT, of the PDCP entity to their initial values. As a result, the PDCP count values (i.e., TX_NEXT and RX_NEXT) of the AM DRB are reset. However, this approach requires the first BEARER CONTEXT MODIFICATION procedure and the second BEARER CONTEXT MODIFICATION procedure. In other words, the gNB-CU-CP needs to send two BEARER CONTEXT MODIFICATION REQUEST messages to the gNB-CU-UP to reset the PDCP count values for the AM DRB. This may increase the amount of signaling exchanged between the gNB-CU-CP and the gNB-CU-UP, and may also increase the time required to reset the PDCP count value for the AM DRB.

This issue may occur not only in 5G systems, but also in radio communication systems that use architectures similar to 5G systems.

One of the objects that the example embodiments disclosed herein seek to achieve is to provide apparatuses, methods, and programs that contribute to facilitating the resetting of a PDCP count value for an Acknowledged Mode (AM) data radio bearer by a radio access network node using an architecture in which its control plane and user plane are separated. It should be noted that this object is only one of the objects to be achieved by the example embodiments disclosed herein. Other objects or problems and novel features will become apparent from the following description and the accompanying drawings.

### Solution to Problem

In a first aspect, an apparatus configured to operate as a central unit control plane of a radio access network node includes at least one memory and at least one processor coupled to the at least one memory. The at least one processor is configured to send to a central unit user plane of the radio access network node a single control message indicating that one or more PDCP count values for an AM data radio bearer already configured for a radio terminal need to be reset.

In a second aspect, an apparatus configured to operate as a central unit user plane of a radio access network node includes at least one memory and at least one processor coupled to the at least one memory. The at least one processor is configured to receive from a central unit control plane of the radio access network node a single control message indicating that one or more PDCP count values for an AM data radio bearer already configured for a radio terminal need to be reset.

In a third aspect, a method performed by a central unit control plane of a radio access network node includes sending to a central unit user plane of the radio access network node a single control message indicating that one or more PDCP count values for an AM data radio bearer already configured for a radio terminal need to be reset.

In a fourth aspect, a method performed by a central unit user plane of a radio access network node includes receiving from a central unit control plane of the radio access network node a single control message indicating that one or more PDCP count values for an AM data radio bearer already configured for a radio terminal need to be reset.

In a fifth aspect, a program includes a set of instructions (software codes) that, when loaded into a computer, cause the computer to perform the method according to the third or fourth aspect described above.

### Advantageous Effects of Invention

According to the aspects described above, it is possible to provide apparatuses, methods and programs that contribute to facilitating the resetting of a PDCP count value for an Acknowledged Mode (AM) data radio bearer by a radio access network node using an architecture in which its control plane and user plane are separated.

### BRIEF DESCRIPTION OF DRAWINGS

FIG. 1 shows an example configuration of a radio communication network according to an example embodiment:

FIG. 2 is a sequence diagram showing an example of signaling according to an example embodiment:

FIG. 3 is a flowchart showing an example of the operation of a central unit control plane according to an example embodiment:

FIG. 4 is a flowchart showing an example of the operation of a central unit user plane according to an example embodiment:

FIG. 5 is a sequence diagram showing an example of signaling according to an example embodiment:

FIG. 6 is a flowchart showing an example of the operation of a central unit control plane according to an example embodiment:

FIG. 7 is a flowchart showing an example of the operation of a central unit user plane according to an example embodiment:

FIG. 8 shows an example of the format of a PDU Session Resource To Modify List information element according to an example embodiment:

FIG. 9 is a sequence diagram showing an example of signaling according to an example embodiment:

FIG. 10 is a flowchart showing an example of the operation of a central unit control plane according to an example embodiment:

FIG. 11 is a flowchart showing an example of the operation of a central unit user plane according to an example embodiment:

FIG. 12 shows an example of the format of a PDU Session Resource To Modify List information element according to an example embodiment:

FIG. 13 is a sequence diagram showing an example of signaling according to an example embodiment:

FIG. 14 is a flowchart showing an example of the operation of a central unit control plane according to an example embodiment:

FIG. 15 is a flowchart showing an example of the operation of a central unit user plane according to an example embodiment:

FIG. 16 shows an example of the format of a PDU Session Resource To Modify List information element according to an example embodiment:

FIG. 17 is a sequence diagram showing an example of signaling according to an example embodiment; and

FIG. 18 is a block diagram showing an example configuration of a central unit control plane and a central unit user plane according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are primarily described for the 3GPP 5G system. However, these example embodiments can be applied to other radio communication systems that use architectures similar to the 5G system. These example embodiments can be applied to other radio communication systems that include a radio access network node that employs an architecture in which its control plane and user plane are separated. More specifically, a radio access network node may be configured to communicate with one or more radio terminals and may include a central unit control plane, one or more central unit user planes, and one or more distributed units. The example embodiments described below may be applied to such a radio access network node.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

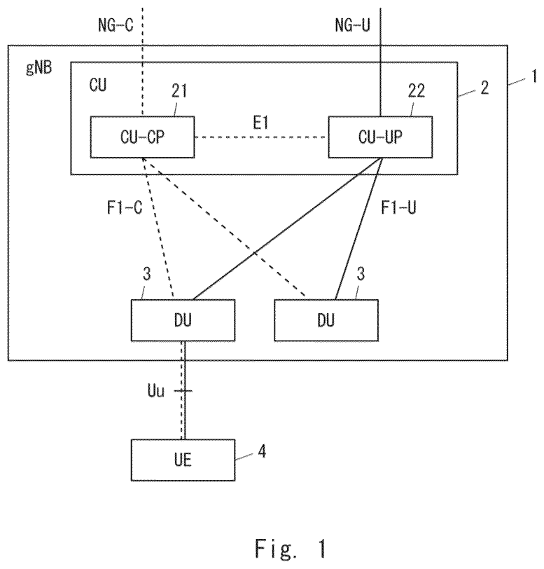

First, the configuration and operation of a plurality of network elements common to a plurality of example embodiments are described. FIG. 1 shows an example configuration of a radio communication system according to a plurality of example embodiments. Each element (or network function) shown in FIG. 1 can be implemented, for example, as a network element on dedicated hardware, as a software instance running on dedicated hardware, or as a virtualized function instantiated on an application platform.

A gNB 1 is a node that provides NR user plane and control plane protocol terminations to a User Equipment (UE) 4 and is connected to a 5G Core Network (5GC) via an NG interface. The NG interface includes an NG Control Plane (NG-C) interface and an NG User Plane (NG-U) interface. The NG-C interface is also referred to as the N2 interface or reference point. The NG-U interface is also referred to as the N3 interface or reference point. The NG-C interface uses the NG Application Protocol (NGAP) to communicate with a control plane node (i.e., Access and Mobility Management Function (AMF)) in the core network. The NG-U interface uses a General Packet Radio Service Tunnelling Protocol User Plane (GTP-U) tunnel and the PDU Session user plane protocol to communicate with a user plane node (i.e., User Plane Function (UPF)) in the core network.

The gNB 1 may be an en-gNB. The en-gNB is a node that provides NR user plane and control plane protocol terminations to the UE and acts as a secondary node for E-UTRA-NR Dual Connectivity (EN-DC).

The gNB 1 includes a gNB Central Unit (CU) 2 and one or more gNB Distributed Units (DUs) 3. The gNB-CU 2 is a logical node that controls the operation of one or more gNB-DUs 3. The gNB-CU 2 hosts the Radio Resource Control (RRC), Service Data Adaptation Protocol (SDAP) and Packet Data Convergence Protocol (PDCP) protocols of the gNB 1. If the gNB 1 is an en-gNB, the gNB-CU 2 hosts the RRC and PDCP protocols of the en-gNB.

The gNB-DU 3 is a logical node that hosts the Radio Link Control (RLC), Medium Access Control (MAC) and Physical (PHY) layers of the gNB 1 (i.e., gNB or en-gNB), and its operation is partially controlled by the gNB-CU. One gNB-DU supports one or more cells. One cell is supported by only one gNB-DU 3. The gNB-DU 3 terminates an F1 interface connected with the gNB-CU 2. The F1 interface includes an F1 Control Plane (F1-C) interface and an F1 User Plane (F1-U) interface.

The gNB-CU 2 includes a gNB-CU Control Plane (CP) 21 and one or more gNB-CU User Planes (CU-UPs) 22. The gNB-CU-CP 21 is a logical node that hosts the RRC and the control plane part of the PDCP protocol of the gNB-CU 2. The gNB-CU-CP 21 terminates an E1 interface connected with each gNB-CU-UP 22 and an F1-C interface connected with each gNB-DU 3. The E1 interface uses the E1 Application Protocol (E1AP). The F1-C interface uses the F1 Application Protocol (F1AP). The gNB-CU-CP 21 also terminates an NG-C interface connected to a control plane node (i.e., AMF) in the core network.

The gNB-CU-UP 22 is a logical node that hosts the user plane part of the PDCP protocol of the gNB-CU 2 for en-gNB or hosts the user plane part of the PDCP protocol and the SDAP protocol of the gNB-CU 2 for a gNB. The gNB-CU-UP 22 terminates the E1 interface connected with the gNB-CU-CP 21 and an F1-U interface connected with each gNB-DU 3. The F1-U interface uses a GTP-U tunnel. The gNB-CU-UP 22 also terminates an NG-U interface connected to a user plane node (i.e., UPF) in the core network.

The gNB 1 shown in FIG. 1 is an example of a radio access network node. The UE 4 shown in FIG. 1 is an example of a radio terminal. The gNB-CU-CP 21 shown in FIG. 1 is an example of a central unit control plane of the radio access network node. The gNB-CU-UP 22 shown in FIG. 1 is an example of a central unit user plane of the radio access network node. The radio access network node communicates with one or more UEs or radio terminals over an air interface. The radio access network node provides signaling to and from a core network and the transfer of user data to and from the core network, enabling these UEs or radio terminals to communicate with the core network and a data network. The radio access network node may be referred to as a base station, a radio station, or an access point.

### First Example Embodiment

The configuration and operation of a radio communication system and network elements (or apparatuses, nodes, devices, or network functions) in this example embodiment may be the same as in the examples described with reference to FIG. 1. This example embodiment provides enhancements to E1AP signaling. In particular, this example embodiment provides enhancements that contribute to facilitating the gNB-CU-CP 21 and the gNB-CU-UP 22 to reset a PDCP count value for an Acknowledged Mode (AM) Data Radio Bearer (DRB).

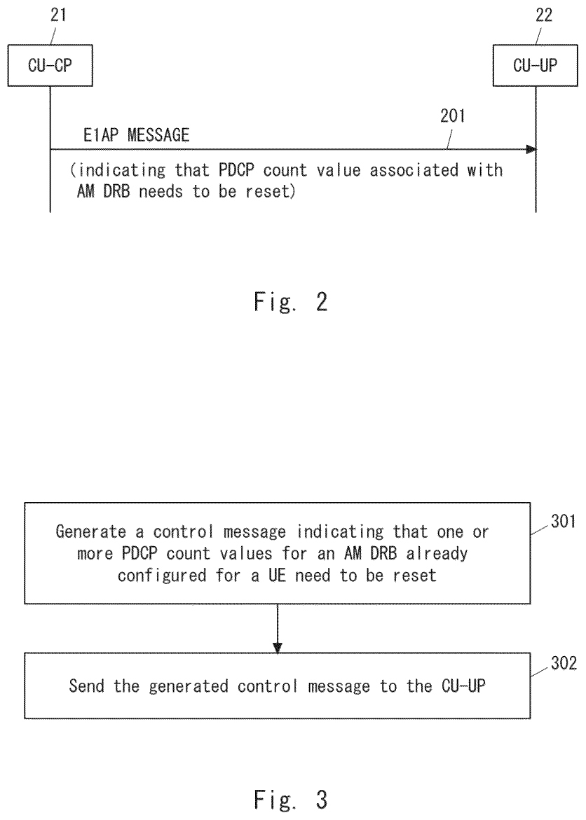

FIG. 2 shows an example of signaling in this example embodiment. In step 201, the gNB-CU-CP 21 sends a single control message to the gNB-CU-UP 22 indicating that one or more PDCP count values for an AM DRB already configured for the UE 4 need to be reset. The control message may indicate that PDCP count values for multiple AM DRBs need to be reset. The control message may be an

E1AP message. In particular, the control message may be a message to be sent to the gNB-CU-UP 22 to request modification of a bearer context. In particular, the control message may be an E1AP BEARER CONTEXT MODIFICATION REQUEST message.

An AM DRB is a data radio bearer that uses Acknowledged Mode (AM) RLC. In other words, an AM DRB is a DRB for which Acknowledged Mode (AM) is used in the RLC sublayer (i.e., gNB-DU 3). AM is one of the three transmission modes (i.e., AM, Unacknowledged Mode (UM), and Transparent Mode (TM)) supported by the RLC sublayer. In AM, the RLC sublayer provides an automatic repeat request (ARQ). In the ARQ, an RLC entity (e.g., an RLC entity in gNB-DU 3) retransmits an RLC SDU or RLC SDU segments based on an RLC Control Protocol Data Unit (PDU) (i.e., STATUS PDU) from a peer RLC entity (e.g., an RLC entity in UE 4).

The control message of step 201 causes the gNB-CU-UP 22 to reset PDCP count values for one or more AM DRBs. The gNB-CU-UP 22 may reset one or more PDCP count values for an AM DRB in response to receiving the control message. Resetting a PDCP count value means that the PDCP count value is set to its initial value.

In some implementations, the one or more PDCP count values for an AM DRB include TX_NEXT and RX_NEXT. TX_NEXT is a state variable that indicates the COUNT value of the next PDCP Service Data Unit (SDU) to be transmitted. The initial value of TX_NEXT for DRBs is 0. RX_NEXT is a state variable that indicates the COUNT value of the next PDCP SDU expected to be received. The initial value of RX_NEXT for DRBs of the Uu interface between the UE 4 and the gNB 1 is 0. Each COUNT value is composed of a Hyper Frame Number (HFN) and a PDCP Sequence Number (SN).

The gNB-CU-CP 21 may send the control message of step 201 to reset the PDCP count value(s) of one or more AM DRBs already configured for the UE 4.

In an example, the gNB-CU-CP 21 may send the control message of step 201 during the preparation phase of an intra-CU inter-DU handover of the UE 4. More specifically, the gNB-CU-CP 21 may receive a control message from a gNB-DU 3 (i.e., target gNB-DU) containing a cell group configuration generated using full configuration. In other words, the gNB-CU-CP 21 may receive a control message from a gNB-DU 3 (i.e., target gNB-DU) containing a cell group configuration and indicating that the cell group configuration has been generated using full configuration. The cell group configuration includes configurations of the RLC sublayer, MAC sublayer, and PHY layer for the UE 4. Full configuration means that no delta signaling or delta configuration from the source cell group configuration of the source gNB-DU is applied. In other words, full configuration means that delta signaling for SDAP and PDCP is not applied during the inter-DU handover. The target cell group configuration of the target gNB-DU generated by full configuration includes all cell group configurations, not only the difference from the source cell group configuration (i.e., the delta configuration).

This control message between CU and DU may be an F1AP message, more specifically an F1AP UE CONTEXT SETUP RESPONSE message. The F1AP UE CONTEXT SETUP RESPONSE message includes a DU To CU RRC Information Element (IE) containing the cell group configuration and may also include a Full Configuration Information Element (IE). In response to receiving this control message (e.g., F1AP UE CONTEXT SETUP RESPONSE message), the gNB-CU-CP 21 may send the message of step 201 (e.g., E1AP BEARER CONTEXT MODIFICATION REQUEST message).

In this case, the gNB-CU-CP 21 may include, in the E1AP BEARER CONTEXT MODIFICATION REQUEST message of step 201, Downlink (DL) Transport Network Layer (TNL) address information received from the gNB-DU 3 (i.e., target gNB-DU) via the F1AP UE CONTEXT SETUP RESPONSE message. The DL TNL address information indicates the endpoint information on the gNB-DU 3 (i.e., target gNB-DU) side of the GTP-U tunnel for the F1-U interface. The DL TNL address information may be referred to as DL UP parameters. This allows the gNB-CU-CP 21 to request the gNB-CU-UP 22 to reset the PDCP count value(s) for an AM DRB and to inform the gNB-CU-UP 22 of the new DL TNL information for that AM DRB, with a single control message.

In another example, the gNB-CU-CP 21 may send the control message of step 201 when the PDCP count value of the AM DRB is about to wrap around, i.e., when the PDCP count value of the AM DRB is approaching its maximum value. In other words, the gNB-CU-CP 21 may send the control message of step 201 in response to a K_{gNB} refresh when the PDCP count value of the AM DRB is about to wrap around. The gNB-CU-CP 21 may perform an RRC Counter check procedure to check the PDCP count value in the UE 4. Specifically, the gNB-CU-CP 21 may send a Counter Check message to the UE 4 and receive a Counter Check Response message from the UE 4 indicating the PDCP count value in the UE 4.

In yet another example, the gNB-CU-CP 21 may send the control message of step 201 in response to performing a refresh of the K_{gNB} based on any other policy or trigger.

FIG. 3 shows an example of the operation of the gNB-CU-CP 21. In step 301, the gNB-CU-CP 21 generates a control message indicating that one or more PDCP count values for an AM DRB configured for the UE 4 need to be reset. The control message may indicate that PDCP count values for multiple AM DRBs need to be reset. In step 302, the gNB-CU-CP 21 sends the generated control message to the gNB-CU-UP 22.

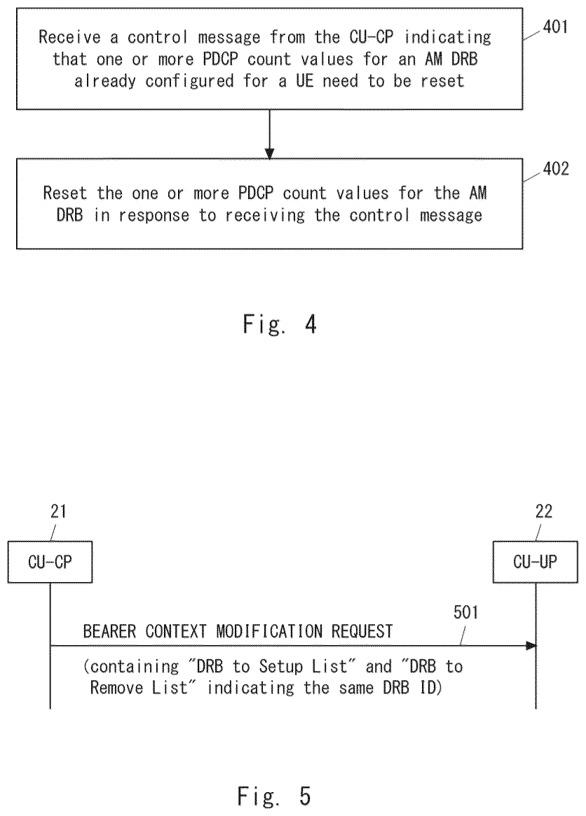

FIG. 4 shows an example of the operation of the gNB-CU-UP 22. In step 401, the gNB-CU-UP 22 receives from the gNB-CU-CP 21 a control message indicating that one or more PDCP count values for an AM DRB configured for the UE 4 need to be reset. The control message may indicate that PDCP count values for multiple AM DRBs need to be reset. In step 402, the gNB-CU-UP 22 resets the PDCP count value(s) of the one or more AM DRBs in response to receiving the control message.

According to the operation of the gNB-CU-CP 21 and the gNB-CU-UP 22 described in this example embodiment, the gNB-CU-CP 21 can request the gNB-CU-UP 22 to reset PDCP count values of one or more AM DRBs by sending a single control message to the gNB-CU-UP 22. This can make it easier for the gNB-CU-CP 21 and the gNB-CU-UP 22 to reset PDCP count values for an AM DRB.

### Second Example Embodiment

The configuration and operation of a radio communication system and network elements (or apparatuses, nodes, devices, or network functions) in this example embodiment may be the same as in the examples described with reference to FIG. 1. This example embodiment provides details of the E1AP signaling enhancements provided in the first example embodiment.

FIG. 5 shows an example of signaling in this example embodiment. In step 501, the gNB-CU-CP 21 sends an E1AP BEARER CONTEXT MODIFICATION REQUEST message to the gNB-CU-UP 22. To indicate that one or more PDCP count values for an AM DRB need to be reset, the BEARER CONTEXT MODIFICATION REQUEST message of step 501 includes a DRB to Setup List and a DRB to Remove List that specify the same DRB identifier (DRB ID) of the AM DRB. To indicate that PDCP count values for multiple AM DRBs need to be reset, the BEARER CONTEXT MODIFICATION REQUEST message may include a DRB to Setup List specifying the DRB IDs of those DRBs and a DRB to Remove List specifying the same DRB IDs.

The DRB to Setup List and the DRB to Remove List specifying the same DRB identifier in the same BEARER CONTEXT MODIFICATION REQUEST message inform the gNB-CU-UP 22 that the AM DRB in question needs to be released and then set up again. In response to receiving the DRB to Setup List and the DRB to Remove List specifying the same DRB identifier, the gNB-CU-UP 22 recognizes that the AM DRB identified by this DRB identifier needs to be released and then setup again. Accordingly, the gNB-CU-UP 22 releases the PDCP entity of the AM DRB and then establishes the PDCP entity of this AM DRB again. Establishing the PDCP entity involves setting the state variables, including TX_NEXT and RX_NEXT, of the PDCP entity to their initial values. As a result, the PDCP count values (i.e., TX_NEXT and RX_NEXT) of the AM DRB are reset.

The gNB-CU-CP 21 may send the BEARER CONTEXT MODIFICATION REQUEST message of step 501 to reset PDCP count values for one or more AM DRBs already configured for the UE 4. The triggers or conditions for sending the message in step 501 may be the same as those described for the message in step 201 in the first example embodiment.

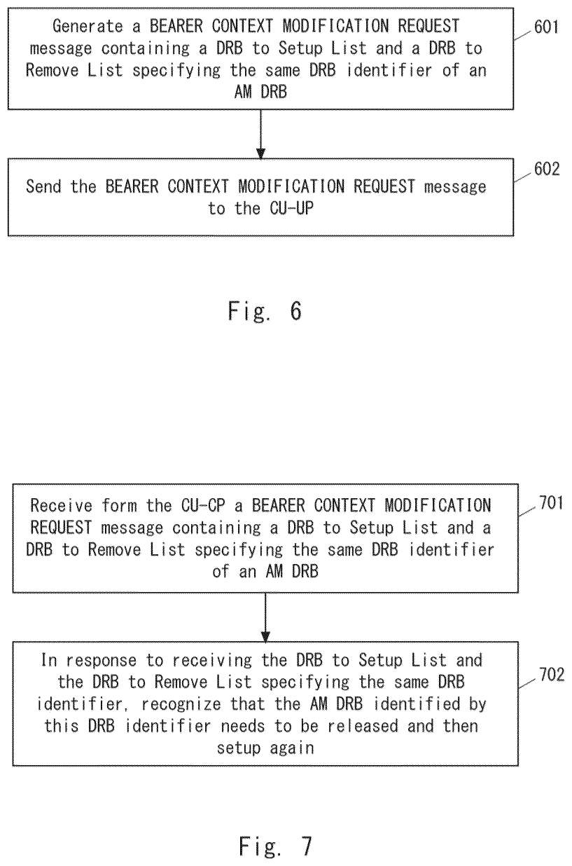

FIG. 6 shows an example of the operation of the gNB-CU-CP 21. In step 601, the gNB-CU-CP 21 generates a BEARER CONTEXT MODIFICATION REQUEST message containing a DRB to Setup List and a DRB to Remove List specifying the same DRB identifier of an AM DRB. In step 602, the gNB-CU-CP 21 sends the generated BEARER CONTEXT MODIFICATION REQUEST message to the gNB-CU-UP 22.

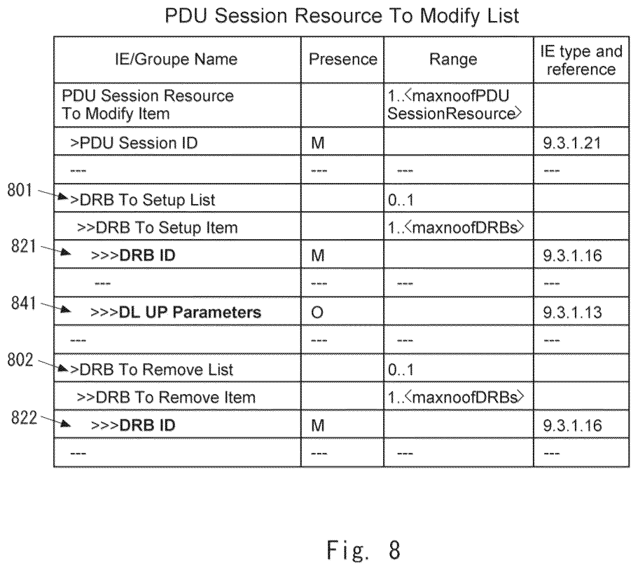

FIG. 7 shows an example of the operation of the gNB-CU-UP 22. In step 701, the gNB-CU-UP 22 receives from the gNB-CU-CP 21 a BEARER CONTEXT MODIFICATION REQUEST message containing a DRB to Setup List and a DRB to Remove List specifying the same DRB identifier of an AM DRB. In step 702, in response to receiving the DRB to Setup List and the DRB to Remove List specifying the same DRB identifier, the gNB-CU-UP 22 recognizes that the AM DRB identified by this DRB identifier needs to be released and then setup again.

The DRB to Setup List and the DRB to Remove List, identifying the same DRB identifier of the AM DRB, may be included in a PDU Session Resource To Modify List Information Element (IE) in the BEARER CONTEXT MODIFICATION REQUEST message. The BEARER CONTEXT MODIFICATION REQUEST message is a UE-associated signaling associated with a specific UE (e.g., UE 4).

FIG. 8 shows an example of the format of the PDU Session Resource To Modify List IE. In the example of FIG. 8, the PDU Session Resource To Modify List IE can include a DRB To Setup List IE 801 and a DRB to Remove List IE 802. The DRB To Setup List IE 801 is a list of one or more DRBs to be set up for the UE 4 and contains configurations of these one or more DRBs. The DRB to Remove List IE 802 is a list of one or more DRBs to be released. The DRB To Setup List IE 801 specifies the DRB ID 821 of each DRB to be set up. Similarly, the DRB to Remove List IE 802 specifies the DRB ID 822 of each DRB to be released. If the DRB ID 821 is the same as the DRB ID 822, the gNB-CU-UP 22 recognizes that the DRB (e.g., AM DRB) identified by this DRB ID needs to be released and then setup again.

As shown in FIG. 8, the DRB To Setup List IE 801 may include a DL UP parameters IE 841. The DL UP parameters IE 841 may specify DL TNL address information of a gNB-DU 3 (e.g., target gNB-DU) with respect to the F1-U interface. For example, during the preparation phase of an intra-CU inter-DU handover, the gNB-CU-CP 21 may receive DL TNL information from the target gNB-DU and include this DL TNL information in the DL UP parameters IE 841.

In particular, the DRB To Setup List IE contained in the existing PDU Session Resource To Modify List IE cannot contain the DL UP parameters IE, as described in section 9.3.3.11 of Non-Patent Literature 1. Therefore, when using the existing format of the PDU Session Resource To Modify List IE, the gNB-CU-CP 21 should send an additional BEARER CONTEXT MODIFICATION REQUEST message containing a DRB To Modify List IE specifying the DL TNL information of the target gNB-DU. In contrast, by using the improved DRB To Setup List IE 801 containing the DL UP parameters IE 841 as shown in FIG. 8, the gNB-CU-CP 21 can request the gNB-CU-UP 22 to reset the PDCP count values of the AM DRB and inform the gNB-CU-UP 22 of the new DL TNL information for this AM DRB, with a single BEARER CONTEXT MODIFICATION REQUEST message.

Although omitted in FIG. 8, the DRB To Setup List IE 801 may contain other information items (or information elements). Similarly, the DRB to Remove List IE 802 may contain other information items (or information elements). These information items (or information elements) may be the same as the existing ones. The format and description of the existing PDU Session Resource To Modify List IE, including the existing DRB To Setup List IE and DRB to Remove List IE, are described in Non-Patent Literature 1 (e.g., sections 8.3.2.2, 9.2.2.4, and 9.3.3.11).

According to the operation of the gNB-CU-CP 21 and the gNB-CU-UP 22 described in this example embodiment, the gNB-CU-CP 21 can request the gNB-CU-UP 22 to reset PDCP count values of one or more AM DRBs by sending a single control message, specifically a BEARER CONTEXT MODIFICATION REQUEST message to the gNB-CU-UP 22. This can make it easier for the gNB-CU-CP 21 and the gNB-CU-UP 22 to reset PDCP count values for an AM DRB.

### Third Example Embodiment

The configuration and operation of a radio communication system and network elements (or apparatuses, nodes, devices, or network functions) in this example embodiment may be the same as in the examples described with reference to FIG. 1. This example embodiment provides details of the E1AP signaling enhancements provided in the first example embodiment.

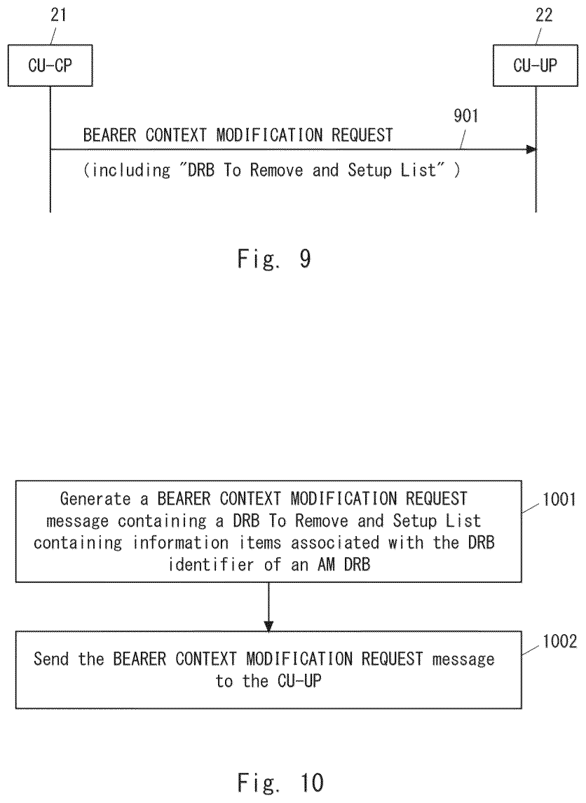

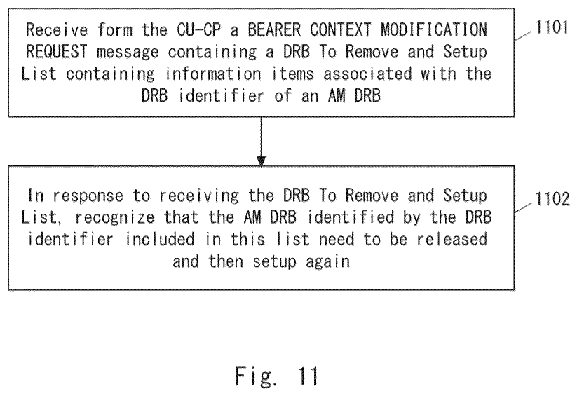

FIG. 9 shows an example of signaling in this example embodiment. In step 901, the gNB-CU-CP 21 sends an E1AP BEARER CONTEXT MODIFICATION REQUEST message to the gNB-CU-UP 22. To indicate that one or more PDCP count values for an AM DRB need to be reset, the BEARER CONTEXT MODIFICATION REQUEST message of step 901 includes a DRB To Remove and Setup List containing one or more information items associated with the DRB identifier (DRB ID) of the AM DRB. To indicate that PDCP count values for multiple AM DRBs need to be reset, the DRB To Remove and Setup List may specify DRB IDs for those DRBs.

The DRB To Remove and Setup List in the single BEARER CONTEXT MODIFICATION REQUEST message informs the gNB-CU-UP 22 that the DRBs (including AM DRB(s)) associated with one or more DRB IDs specified in this list need to be released and then set up again. In response to receiving the DRB To Remove and Setup List, the gNB-CU-UP 22 recognizes that the DRBs (including AM DRB(s)) associated with one or more DRB IDs specified in this list need to be released and then setup again. Accordingly, the gNB-CU-UP 22 releases the PDCP entities of the relevant AM DRB(s) and then establishes the PDCP entities of these AM DRB(s) again. Establishing the PDCP entity involves setting the state variables, including TX_NEXT and RX_NEXT, of the PDCP entity to their initial values. As a result, the PDCP count values (i.e., TX_NEXT and RX_NEXT) of the AM DRB(s) are reset.

The gNB-CU-CP 21 may send the BEARER CONTEXT MODIFICATION REQUEST message of step 901 to reset PDCP count values for one or more AM DRBs already configured for the UE 4. The triggers or conditions for sending the message in step 901 may be the same as those described for the message in step 201 in the first example embodiment.

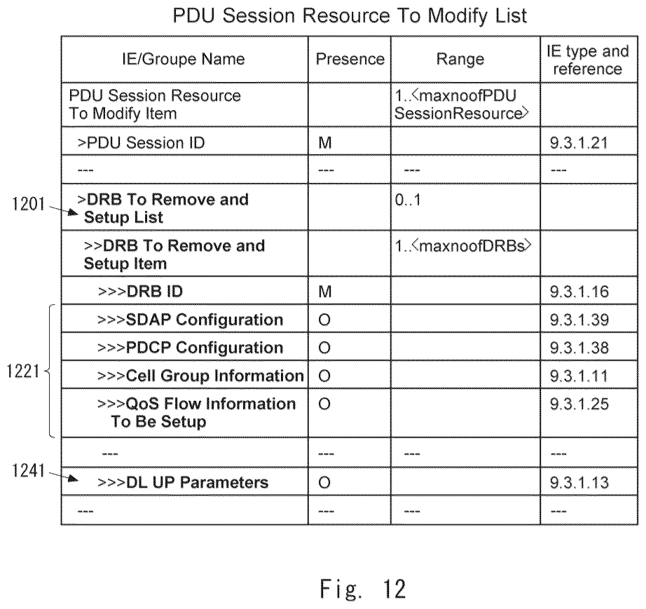

FIG. 10 shows an example of the operation of the gNB-CU-CP 21. In step 1001, the gNB-CU-CP 21 generates a BEARER CONTEXT MODIFICATION REQUEST message containing a DRB To Remove and Setup List containing information items associated with the DRB identifier of an AM DRB. In step 1002, the gNB-CU-CP 21 sends the generated BEARER CONTEXT MODIFICATION REQUEST message to the gNB-CU-UP 22.

FIG. 11 shows an example of the operation of the gNB-CU-UP 22. In step 1101, the gNB-CU-UP 22 receives from the gNB-CU-CP 21 a BEARER CONTEXT MODIFICATION REQUEST message containing a DRB To Remove and Setup List containing information items associated with the DRB identifier of an AM DRB. In step 1102, in response to receiving the DRB To Remove and Setup List, the gNB-CU-UP 22 recognizes that the AM DRB(s) identified by the DRB identifier(s) included in this list need to be released and then setup again.

The DRB To Remove and Setup List may be included in a PDU Session Resource To Modify List IE in the BEARER CONTEXT MODIFICATION REQUEST message. The BEARER CONTEXT MODIFICATION REQUEST message is a UE-associated signaling associated with a specific UE (e.g., UE 4).

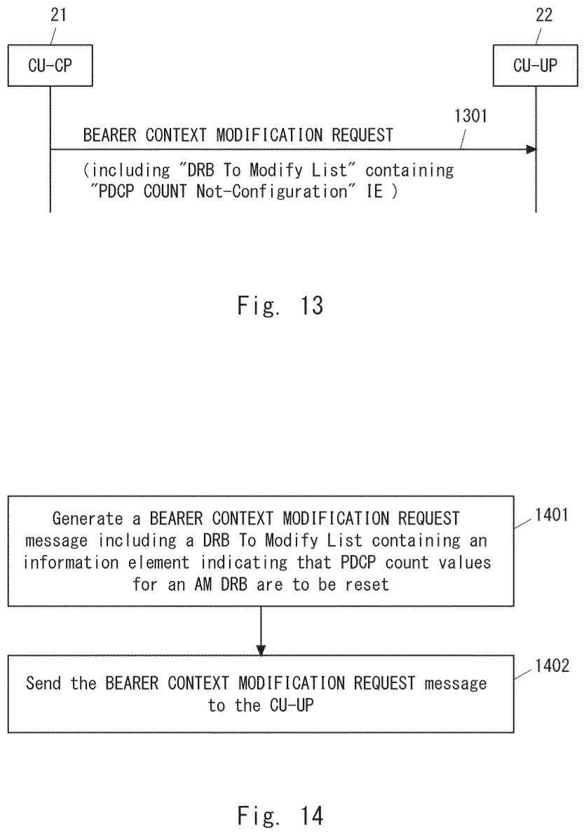

FIG. 12 shows an example of the format of the PDU Session Resource To Modify List IE. In the example of FIG. 12, the PDU Session Resource To Modify List IE can include a DRB To Remove and Setup List IE 1201. The DRB To Remove and Setup List IE 1201 corresponds to the DRB To Remove and Setup List described above. The DRB To Remove and Setup List IE 1201 specifies one or more DRB IDs of one or more DRBs to be released and re-set up. The DRB To Remove and Setup List IE 1201 may contain configurations 1221 of these one or more DRBs. If some or all of these configurations 1221 are omitted, the gNB-CU-UP 22 may understand that the omitted configurations are the same as the current configurations before the DRB release. Alternatively, the DRB To Remove and Setup List IE 1201 may include the configurations 1221 as mandatory information elements.

As shown in FIG. 12, the DRB To Remove and Setup List IE 1201 may include a DL UP parameters IE 1241. The DL UP parameters IE 1241 may specify DL TNL address information of a gNB-DU 3 (e.g., target gNB-DU) with respect to the F1-U interface. For example, during the preparation phase of an intra-CU inter-DU handover, the gNB-CU-CP 21 may receive DL TNL information from the target gNB-DU and include this DL TNL information in the DL UP parameters IE 1241. This allows the gNB-CU-CP 21 to request the gNB-CU-UP 22 to reset the PDCP count values of the AM DRB and inform the gNB-CU-UP 22 of the new DL TNL information for this AM DRB, with a single BEARER CONTEXT MODIFICATION REQUEST message.

Although omitted in FIG. 12, the DRB To Remove and Setup List IE 1201 may contain other information items (or information elements). These information items (or information elements) may be the same as those contained in the existing DRB To Setup List IE or DRB To Modify List IE. The format and description of the existing PDU Session Resource To Modify List IE, including the existing DRB To Setup List IE and DRB to Modify List IE, are described in Non-Patent Literature 1 (e.g., sections 8.3.2.2, 9.2.2.4, and 9.3.3.11).

According to the operation of the gNB-CU-CP 21 and the gNB-CU-UP 22 described in this example embodiment, the gNB-CU-CP 21 can request the gNB-CU-UP 22 to reset PDCP count values of one or more AM DRBs by sending a single control message, specifically a BEARER CONTEXT MODIFICATION REQUEST message to the gNB-CU-UP 22. This can make it easier for the gNB-CU-CP 21 and the gNB-CU-UP 22 to reset PDCP count values for an AM DRB.

### Fourth Example Embodiment

The configuration and operation of a radio communication system and network elements (or apparatuses, nodes, devices, or network functions) in this example embodiment may be the same as in the examples described with reference to FIG. 1. This example embodiment provides details of the E1AP signaling enhancements provided in the first example embodiment.

FIG. 13 shows an example of signaling in this example embodiment. In step 1301, the gNB-CU-CP 21 sends an E1AP BEARER CONTEXT MODIFICATION REQUEST message to the gNB-CU-UP 22. The BEARER CONTEXT MODIFICATION REQUEST message includes a DRB To Modify List containing one or more information items associated with the DRB identifier of an AM DRB. To indicate that one or more PDCP count values for the AM DRB need to be reset, the one or more information items in the DRB To Modify List include an information item indicating that the PDCP count values are to be reset. The information item (or information element) indicating that the PDCP count values are to be reset may be named, but is not limited to, “PDCP COUNT Not-Configuration”. This information item (or information element) may indicate that the one or more PDCP count values for the AM DRB are not to be inherited.

The information item (or information element) indicating that the PDCP count values are to be reset informs the gNB-CU-UP 22 that the PDCP count values for the DRB (e.g., AM DRB) identified by the DRB identifier associated with this information item need to be reset. In response to receiving the information item (or information element), the gNB-CU-UP 22 resets the PDCP count values (e.g., TX_NEXT and RX_NEXT) for the DRB (e.g., AM DRB) identified by the DRB identifier associated with this information item.

The gNB-CU-CP 21 may send the BEARER CONTEXT MODIFICATION REQUEST message of step 1301 to reset PDCP count values for one or more AM DRBs already configured for the UE 4. The triggers or conditions for sending the message in step 1301 may be the same as those described for the message in step 201 in the first example embodiment.

FIG. 14 shows an example of the operation of the gNB-CU-CP 21. In step 1401, the gNB-CU-CP 21 generates a BEARER CONTEXT MODIFICATION REQUEST message including a DRB To Modify List containing an information element indicating that PDCP count values for an AM DRB are to be reset. The information element may indicate that the PDCP count values for the AM DRB are not to be inherited. In step 1402, the gNB-CU-CP 21 sends the generated BEARER CONTEXT MODIFICATION REQUEST message to the gNB-CU-UP 22.

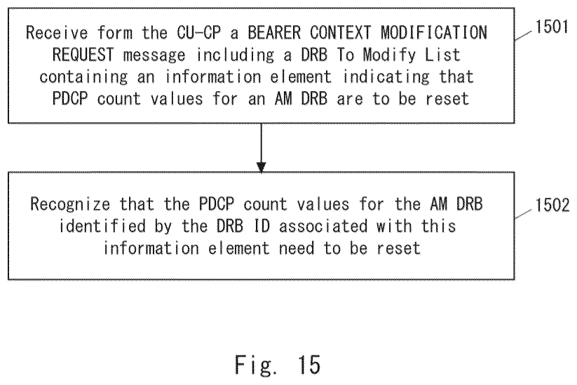

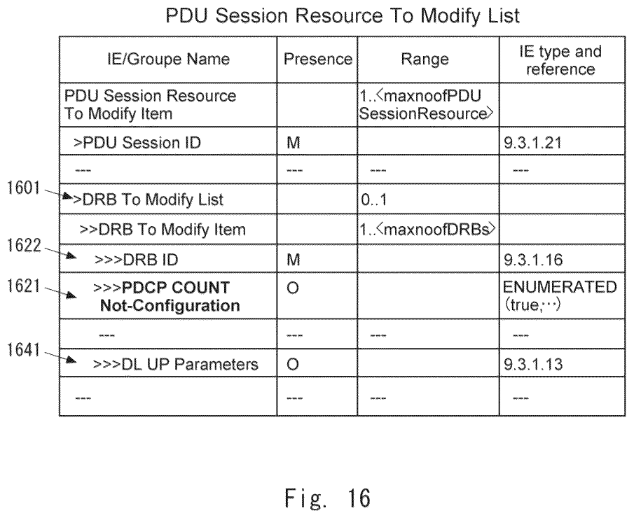

FIG. 15 shows an example of the operation of the gNB-CU-UP 22. In step 1501, the gNB-CU-UP 22 receives from the gNB-CU-CP 21 a BEARER CONTEXT MODIFICATION REQUEST message including a DRB To Modify List containing an information element indicating that PDCP count values for an AM DRB are to be reset. The information element may indicate that the PDCP count values for the AM DRB are not to be inherited. In step 1102, in response to receiving the information element, the gNB-CU-UP 22 recognizes that the PDCP count values for the AM DRB identified by the DRB ID associated with this information element need to be reset. Alternatively, the gNB-CU-UP 22 may recognize that the PDCP count values for the AM DRB identified by the DRB ID associated with this information element will not be inherited, and the gNB-CU-UP 22 may reset the PDCP count values accordingly.

The DRB To Modify List may be included in a PDU Session Resource To Modify List IE in the BEARER CONTEXT MODIFICATION REQUEST message. The BEARER CONTEXT MODIFICATION REQUEST message is a UE-associated signaling associated with a specific UE (e.g., UE 4).

FIG. 16 shows an example of the format of the PDU Session Resource To Modify List IE. In the example of FIG. 16, the PDU Session Resource To Modify List IE can include a DRB To Modify List IE 1601. The DRB To Modify List IE 1601 can include a PDCP COUNT Not-Configuration IE 1621. The name of the PDCP COUNT Not-Configuration IE 1621 is an example and is not limited to it. The PDCP COUNT Not-Configuration IE 1621 indicates that the PDCP count values of the DRB (e.g., AM DRB) identified by the DRB ID specified in the associated DRB ID IE 1622 need to be reset. Alternatively, the PDCP COUNT Not-Configuration IE 1621 indicates that the PDCP count values of the DRB (e.g., AM DRB) identified by the associated DRB ID IE 1622 are not to be inherited. The PDCP COUNT Not-Configuration IE 1621 can be an enumerated-type IE.

As shown in FIG. 16, the DRB To Modify List IE 1601 may include a DL UP parameters IE 1641. The DL UP parameters IE 1641 may specify DL TNL address information of a gNB-DU 3 (e.g., target gNB-DU) with respect to the F1-U interface. For example, during the preparation phase of an intra-CU inter-DU handover, the gNB-CU-CP 21 may receive DL TNL information from the target gNB-DU and include this DL TNL information in the DL UP parameters IE 1641. This allows the gNB-CU-CP 21 to request the gNB-CU-UP 22 to reset the PDCP count values of the AM DRB and inform the gNB-CU-UP 22 of the new DL TNL information for this AM DRB, with a single BEARER CONTEXT MODIFICATION REQUEST message.

Although omitted in FIG. 16, the DRB To Modify List IE 1601 may contain other information items (or information elements). These information items (or information elements) may be the same as those contained in the existing DRB To Modify List IE. The format and description of the existing PDU Session Resource To Modify List IE, including the existing DRB to Modify List IE, are described in Non-Patent Literature 1 (e.g., sections 8.3.2.2, 9.2.2.4, and 9.3.3.11).

According to the operation of the gNB-CU-CP 21 and the gNB-CU-UP 22 described in this example embodiment, the gNB-CU-CP 21 can request the gNB-CU-UP 22 to reset PDCP count values of one or more AM DRBs by sending a single control message, specifically a BEARER CONTEXT MODIFICATION REQUEST message to the gNB-CU-UP 22. This can make it easier for the gNB-CU-CP 21 and the gNB-CU-UP 22 to reset PDCP count values for an AM DRB.

### Fifth Example Embodiment

The configuration and operation of a radio communication system and network elements (or apparatuses, nodes, devices, or network functions) in this example embodiment may be the same as in the examples described with reference to FIG. 1. This example embodiment provides details of the E1AP signaling enhancements provided in the first through fourth example embodiments.

As described above, the gNB-CU-CP 21 may send the control message of the first example embodiment (e.g., step 201 in FIG. 2) to the gNB-CU-UP 22 during the preparation phase of an intra-CU inter-DU handover of the UE 4. Similarly, the gNB-CU-CP 21 may send the BEARER CONTEXT MODIFICATION REQUEST message of the second, third, or fourth example embodiment (e.g., step 501 in FIG. 5, step 901 in FIG. 9, or Step 1301 in FIG. 13) during the preparation phase of an intra-CU inter-DU handover of the UE 4.

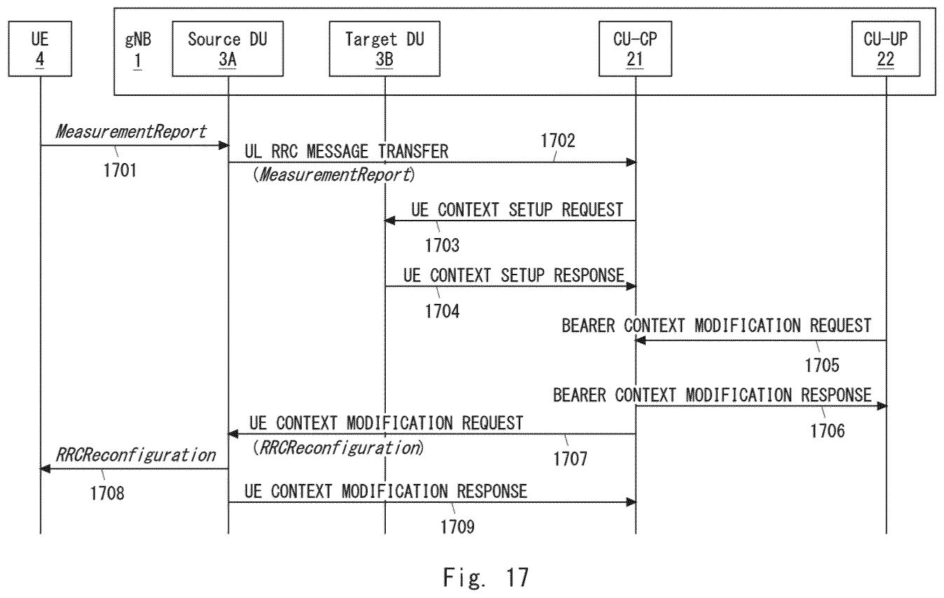

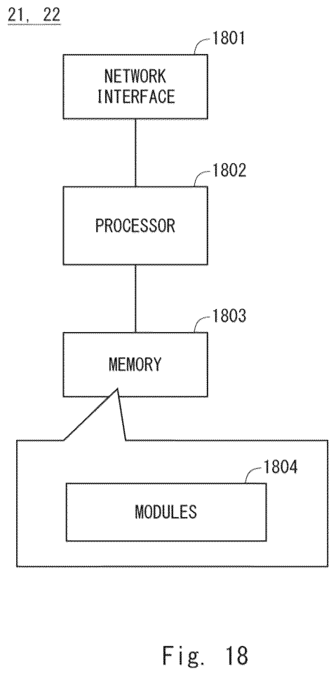

FIG. 17 shows an example of signaling during the preparation phase of an intra-CU inter-DU handover of the UE 4. In step 1701, the UE 4 transmits a measurement report message (e.g., RRC MeasurementReport message) to the source gNB-DU 3A. In step 1702, the source gNB-DU 3A sends a UL RRC MESSAGE TRANSFER message to the gNB-CU-CP 21 to forward the received measurement report message.

Before step 1703, the gNB-CU-CP 21 may send an F1AP UE CONTEXT MODIFICATION REQUEST message to the source gNB-DU 3A to request the latest configuration. In this case, the source gNB-DU 3A responds with a UE CONTEXT MODIFICATION RESPONSE message containing the full configuration information, i.e., the CellGroupConfig IE.

In step 1703, the gNB-CU-CP 21 sends a UE CONTEXT SETUP REQUEST message to the target gNB-DU 3B to create a UE context and set up one or more DRBs. The UE CONTEXT SETUP REQUEST message contains handover preparation information (e.g., HandoverPreparationInformation IE).

In step 1704, the target gNB-DU 3B responds to the gNB-CU-CP 21 with a UE CONTEXT SETUP RESPONSE message. The UE CONTEXT SETUP RESPONSE message indicates the DL TNL information of the target gNB-DU 3B. The UE CONTEXT SETUP RESPONSE message may contain the cell group configuration (i.e., CellGroupConfig IE) generated using full configuration.

In step 1705, the gNB-CU-CP 21 sends a BEARER CONTEXT MODIFICATION REQUEST message to the gNB-CU-UP 22 to modify or update the bearer context for the UE 4. The BEARER CONTEXT MODIFICATION REQUEST message indicates that the PDCP count values of one or more AM DRBs for the UE 4 need to be reset. This BEARER CONTEXT MODIFICATION REQUEST message may contain the same or similar information as that contained in the control message of the first example embodiment (e.g., step 201 in FIG. 2) or the BEARER CONTEXT MODIFICATION REQUEST message of the second, third, or fourth example embodiment (e.g., step 501 in FIG. 5, step 901 in FIG. 9, or Step 1301 in FIG. 13).

The BEARER CONTEXT MODIFICATION REQUEST message of step 1705 indicates the DL TNL information of the target gNB-DU 3B. As described with reference to FIG. 8, the gNB-CU-CP 21 may include the DL UP parameters IE (841) indicating the DL TNL information of the gNB-DU 3B in the DRB To Setup List IE (801) in the PDU Session Resource To Modify List IE in the BEARER CONTEXT MODIFICATION REQUEST message. As described with reference to FIG. 12, the gNB-CU-CP 21 may include the DL UP parameters IE (1241) indicating the DL TNL information of the gNB-DU 3B in the DRB To Remove and Setup List IE (1201) in the PDU Session Resource To Modify List IE in the BEARER CONTEXT MODIFICATION REQUEST message. Alternatively, as described with reference to FIG. 16, the gNB-CU-CP 21 may include the DL UP parameters IE (1641) indicating the DL TNL information of the gNB-DU 3B in the DRB To Modify List IE (1601) in the PDU Session Resource To Modify List IE in the BEARER CONTEXT MODIFICATION REQUEST message.

In step 1706, the gNB-CU-UP 22 responds to the gNB-CU-CP 21 with a BEARER CONTEXT MODIFICATION RESPONSE message. The gNB-CU-CP 21 generates an RRCReconfiguration message to be sent to the UE 4.

In step 1707, the gNB-CU-CP 21 sends a UE CONTEXT MODIFICATION REQUEST message containing the generated RRCReconfiguration message to the source gNB-DU 3A. The UE CONTEXT MODIFICATION REQUEST message may instruct the source gNB-DU 3A to stop sending data for the UE 4.

In step 1708, the source gNB-DU 3A forwards the received RRCReconfiguration message to the UE 4.

In step 1709, the source gNB-DU 3A responds to the gNB-CU-CP 21 with a UE CONTEXT MODIFICATION RESPONSE message.

According to the procedure described with reference to FIG. 17, during the preparation phase of an intra-CU inter-DU handover of the UE 4, the gNB-CU-CP 21 can request the gNB-CU-UP 22 to reset the PDCP count values for AM DRB(s) of the UE 4 and also inform the gNB-CU-UP 22 of the new DL TNL information for these AM DRB(s), with a single E1AP message (step 1705).

Examples of configurations of the gNB-CU-CP 21 and the gNB-CU-UP 22 according to the plurality of example embodiments described above are provided below. FIG. 18 is a block diagram showing an example configuration of the gNB-CU-CP 21 and the gNB-CU-UP 22 according to the example embodiments described above.

Referring to FIG. 18, the gNB-CU-CP 21 or the gNB-CU-UP 22 includes a network interface 1801, a processor 1802, and a memory 1803. The network interface 1803 is used to communicate with network nodes (e.g., other RAN nodes, and control and transfer nodes in the core network). The network interface 1801 is used to communicate with network nodes (e.g., gNB-CU-UP 22 or gNB-CU-CP 21, gNB-DU 3, and control plane (CP) nodes or user plane (UP) nodes in the core network). The network interface 1801 may include a plurality of interfaces. For example, the network interface 1801 may include a fiber optic interface for communication between a CU and a DU and a network interface compliant with the IEEE 802.3 series.

For example, in the case of the gNB-CU-CP 21, the processor 1802 performs control plane processing, such as processing related to NGAP, RRC, E1AP, and FLAP signaling. For example, in the case of the gNB-CU-UP 22, the processor 1802 performs NG-U interface termination, F1-U interface termination, and data processing for the SDAP and PDCP sublayers. The processor 1802 may include a plurality of processors.

The memory 1803 consists of a combination of a volatile memory and a non-volatile memory. The memory 1803 may include multiple physically independent memory devices. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1803 may include a storage located away from the processor 1802. In this case, the processor 1802 may access the memory 1803 through the network interface 1801 or another I/O interface.

The memory 1803 may store one or more software modules (computer programs) 1804 including instructions and data for performing processing by the gNB-CU-CP 21 or the gNB-CU-UP 22 described in the above example embodiments. In some implementations, the processor 1802 may be configured to load and execute the software module(s) 1804 from the memory 1803, thereby performing the processing of the gNB-CU-CP 21 or the gNB-CU-UP 22 described in the above example embodiments.

As described using FIG. 18, each of the processors of the gNB-CU-CP 21 and the gNB-CU-UP 22 according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### (Supplementary Note 1)

An apparatus configured to operate as a central unit control plane of a radio access network node, the apparatus comprising:
at least one memory; and
at least one processor coupled to the at least one memory and configured to:
   send to a central unit user plane of the radio access network node a single control message indicating that one or more Packet Data Convergence Protocol (PDCP) count values for an Acknowledged Mode (AM) data radio bearer (DRB) already configured for a radio terminal need to be reset.

### (Supplementary Note 2)

The apparatus according to Supplementary Note 1, wherein the control message causes the central unit user plane to reset the one or more PDCP count values for the AM DRB.

### (Supplementary Note 3)

The apparatus according to Supplementary Note 1 or 2, wherein
the central unit control plane is a gNB Central Unit Control Plane (CU-CP), and
the central unit user plane is a gNB Central Unit User Plane (CU-UP).

### (Supplementary Note 4)

The apparatus according to any one of Supplementary Notes 1 to 3, wherein the control message is a message sent to the central unit user plane to request modification of a bearer context.

### (Supplementary Note 5)

The apparatus according to any one of Supplementary Notes 1 to 4, wherein the control message is an E1 Application Protocol (E1AP) BEARER CONTEXT MODIFICATION REQUEST message.

### (Supplementary Note 6)

The apparatus according to any one of Supplementary Notes 1 to 5, wherein the control message includes a DRB to Setup List and a DRB to Remove List that specify a same DRB identifier of the AM DRB to indicate that the one or more PDCP count values for the AM DRB need to be reset.

### (Supplementary Note 7)

The apparatus according to Supplementary Note 6, wherein the DRB to Setup List and the DRB to Remove List, which specify the same DRB identifier, inform the central unit user plane that the AM DRB needs to be released and then set up again.

### (Supplementary Note 8)

The apparatus according to Supplementary Note 6 or 7, wherein the at least one processor is configured to include, in one or more information items included in the DRB to Setup List and associated with the DRB identifier, downlink transport network layer address information received from a distributed unit of the radio access network node and for a user plane interface between the distributed unit and the central unit user plane.

### (Supplementary Note 9)

The apparatus according to any one of Supplementary Notes 1 to 5, wherein the control message includes a DRB To Remove and Setup

List containing one or more information items associated with a DRB identifier of the AM DRB to indicate that the one or more PDCP count values for the AM DRB need to be reset.

### (Supplementary Note 10)

The apparatus according to Supplementary Note 9, wherein the DRB To Remove and Setup List informs the central unit user plane that the AM DRB needs to be released and then set up again.

### (Supplementary Note 11)

The apparatus according to Supplementary Note 9 or 10, wherein the at least one processor is configured to include, in the one or more information items included in the DRB To Remove and Setup List, downlink transport network layer address information received from a distributed unit of the radio access network node and for a user plane interface between the distributed unit and the central unit user plane.

### (Supplementary Note 12)

The apparatus according to any one of Supplementary Notes 1 to 5, wherein the control message includes a DRB To Modify List containing one or more information items associated with a DRB identifier of the AM DRB, wherein
the one or more information items include an information item indicating that the one or more PDCP count values for the AM DRB are to be reset, to indicate that one or more PDCP count values for the AM DRB need to be reset.

### (Supplementary Note 13)

The apparatus according to any one of Supplementary Notes 1 to 12, wherein the one or more PDCP count values include a first count value of a next PDCP Service Data Unit (SDU) to be transmitted with respect to the AM DRB and a second count value of a next PDCP SDU expected to be received with respect to the AM DRB.

### (Supplementary Note 14)

The apparatus according to any one of Supplementary Notes 1 to 13, wherein each of the PDCP count values is composed of a Hyper Frame Number (HFN) and a PDCP Sequence Number (SN).

### (Supplementary Note 15)

The apparatus according to any one of Supplementary Notes 1 to 14, wherein the at least one processor is configured to, in response to receiving from a distributed unit of the radio access network node a UE CONTEXT SETUP RESPONSE message containing a cell group configuration generated using full configuration, send the control message to the central unit user plane.

### (Supplementary Note 16)

The apparatus according to Supplementary Note 15, wherein the at least one processor is configured to include, in the control message, downlink transport network layer address information received from the distributed unit via the UE CONTEXT SETUP RESPONSE message and for a user plane interface between the distributed unit and the central unit user plane.

### (Supplementary Note 17)

An apparatus configured to operate as a central unit user plane of a radio access network node, the apparatus comprising:
at least one memory; and
at least one processor coupled to the at least one memory and configured to:
   receive from a central unit control plane of a radio access network node a single control message indicating that one or more Packet Data Convergence Protocol (PDCP) count values for an Acknowledged Mode (AM) data radio bearer (DRB) already configured for a radio terminal need to be reset.

### (Supplementary Note 18)

The apparatus according to Supplementary Note 17, wherein the at least one processor is configured to reset the one or more PDCP count values for the AM DRB in response to receiving the control message.

### (Supplementary Note 19)

The apparatus according to Supplementary Note 17 or 18, wherein
the central unit control plane is a gNB Central Unit Control Plane (CU-CP), and
the central unit user plane is a gNB Central Unit User Plane (CU-UP).

### (Supplementary Note 20)

The apparatus according to any one of Supplementary Notes 17 to 19, wherein the control message is a message sent to the central unit user plane to request modification of a bearer context.

### (Supplementary Note 21)

The apparatus according to any one of Supplementary Notes 17 to 20, wherein the control message is an E1 Application Protocol (E1AP) BEARER CONTEXT MODIFICATION REQUEST message.

### (Supplementary Note 22)

The apparatus according to any one of Supplementary Notes 17 to 21, wherein the control message includes a DRB to Setup List and a DRB to Remove List that specify a same DRB identifier of the AM DRB to indicate that the one or more PDCP count values for the AM DRB need to be reset.

### (Supplementary Note 23)

The apparatus according to Supplementary Note 22, wherein the DRB to Setup List and the DRB to Remove List, which indicate the same DRB identifier, inform the central unit user plane that the AM DRB needs to be released and then set up again.

### (Supplementary Note 24)

The apparatus according to Supplementary Note 22 or 23, wherein one or more information items included in the DRB to Setup List and associated with the DRB identifier includes downlink transport network layer address information received by the central unit control plane from a distributed unit of the radio access network node and for a user plane interface between the distributed unit and the central unit user plane.

### (Supplementary Note 25)

The apparatus according to any one of Supplementary Notes 17 to 21, wherein the control message includes a DRB To Remove and Setup List containing one or more information items associated with a DRB identifier of the AM DRB to indicate that the one or more PDCP count values for the AM DRB need to be reset.

### (Supplementary Note 26)

The apparatus according to Supplementary Note 25, wherein the DRB To Remove and Setup List informs the central unit user plane that the AM DRB needs to be released and then set up again.

### (Supplementary Note 27)

The apparatus according to Supplementary Note 25 or 26, wherein the one or more information items included in the DRB To Remove and Setup List includes downlink transport network layer address information received by the central unit control plane from a distributed unit of the radio access network node and for a user plane interface between the distributed unit and the central unit user plane.

### (Supplementary Note 28)

The apparatus according to any one of Supplementary Notes 17 to 21, wherein the control message includes a DRB To Modify List containing one or more information items associated with a DRB identifier of the AM DRB, wherein
the one or more information items include an information item indicating that the one or more PDCP count values for the AM DRB are to be reset, to indicate that one or more PDCP count values for the AM DRB need to be reset.

### (Supplementary Note 29)

The apparatus according to any one of Supplementary Notes 17 to 28, wherein the one or more PDCP count values include a first count value of a next PDCP Service Data Unit (SDU) to be transmitted with respect to the AM DRB and a second count value of a next PDCP SDU expected to be received with respect to the AM DRB.

### (Supplementary Note 30)

The apparatus according to any one of Supplementary Notes 17 to 29, wherein each of the PDCP count values is composed of a Hyper Frame Number (HFN) and a PDCP Sequence Number (SN).

### (Supplementary Note 31)

A method performed by a central unit control plane of a radio access network node, the method comprising:
sending to a central unit user plane of the radio access network node a single control message indicating that one or more Packet Data Convergence Protocol (PDCP) count values for an Acknowledged Mode (AM) data radio bearer (DRB) already configured for a radio terminal need to be reset.

### (Supplementary Note 32)

A method performed by a central unit user plane of a radio access network node, the method comprising:
receiving from a central unit control plane of a radio access network node a single control message indicating that one or more Packet Data Convergence Protocol (PDCP) count values for an Acknowledged Mode (AM) data radio bearer (DRB) already configured for a radio terminal need to be reset.

### (Supplementary Note 33)

A program for causing a computer to perform a method for a central unit control plane of a radio access network node,
the method comprising sending to a central unit user plane of the radio access network node a single control message indicating that one or more Packet Data Convergence Protocol (PDCP) count values for an Acknowledged Mode (AM) data radio bearer (DRB) already configured for a radio terminal need to be reset.

### (Supplementary Note 34)

A program for causing a computer to perform a method for a central unit user plane of a radio access network node,
the method comprising receiving from a central unit control plane of a radio access network node a single control message indicating that one or more Packet Data Convergence Protocol (PDCP) count values for an Acknowledged Mode (AM) data radio bearer (DRB) already configured for a radio terminal need to be reset.

This application is based upon and claims the benefit of priority from Japanese Patent Application No. 2022-054841, filed on Mar. 30, 2022, the disclosure of which is incorporated herein in its entirety by reference.

### REFERENCE SIGNS LIST

1 gNB
2 gNB-CU
3 gNB-DU
3A Source gNB-DU
3B Target gNB-DU
4 UE
21 gNB-CU-CP
22 gNB-CU-UP
1802 Processor
1803 Memory
1804 Modules

What is claimed is:

1. An apparatus configured to operate as a central unit control plane of a radio access network node, the apparatus comprising:
at least one memory; and
at least one processor coupled to the at least one memory and configured to:
send to a central unit user plane of the radio access network node a single control message indicating that one or more Packet Data Convergence Protocol (PDCP) count values for an Acknowledged Mode (AM) data radio bearer (DRB) already configured for a radio terminal need to be reset.

2. The apparatus according to claim 1, wherein the control message causes the central unit user plane to reset the one or more PDCP count values for the AM DRB.

3. The apparatus according to claim 1, wherein
the central unit control plane is a gNB Central Unit Control Plane (CU-CP), and
the central unit user plane is a gNB Central Unit User Plane (CU-UP).

4. The apparatus according to claim 1, wherein the control message is a message sent to the central unit user plane to request modification of a bearer context.

5. The apparatus according to claim 1, wherein the control message is an E1 Application Protocol (E1AP) BEARER CONTEXT MODIFICATION REQUEST message.

6. The apparatus according to claim 1, wherein the control message includes a DRB to Setup List and a DRB to Remove List that specify a same DRB identifier of the AM DRB to indicate that the one or more PDCP count values for the AM DRB need to be reset.

7. The apparatus according to claim 6, wherein the DRB to Setup List and the DRB to Remove List, which indicate the same DRB identifier, inform the central unit user plane that the AM DRB needs to be released and then set up again.

8. The apparatus according to claim 6, wherein the at least one processor is configured to include, in one or more information items included in the DRB to Setup List and associated with the DRB identifier, downlink transport network layer address information received from a distributed unit of the radio access network node and for a user plane interface between the distributed unit and the central unit user plane.

9. The apparatus according to claim 1, wherein the control message includes a DRB To Remove and Setup List containing one or more information items associated with a DRB identifier of the AM DRB to indicate that the one or more PDCP count values for the AM DRB need to be reset.

10. The apparatus according to claim 9, wherein the DRB To Remove and Setup List informs the central unit user plane that the AM DRB needs to be released and then set up again.

11. The apparatus according to claim 9, wherein the at least one processor is configured to include, in the one or more information items included in the DRB To Remove and Setup List, downlink transport network layer address information received from a distributed unit of the radio access network node and for a user plane interface between the distributed unit and the central unit user plane.

12. The apparatus according to claim 1, wherein the control message includes a DRB To Modify List containing one or more information items associated with a DRB identifier of the AM DRB, wherein
the one or more information items include an information item indicating that the one or more PDCP count values for the AM DRB are to be reset, to indicate that one or more PDCP count values for the AM DRB need to be reset.

13. The apparatus according to claim 1, wherein the one or more PDCP count values include a first count value of a next PDCP Service Data Unit (SDU) to be transmitted with respect to the AM DRB and a second count value of a next PDCP SDU expected to be received with respect to the AM DRB.

14. The apparatus according to claim 1, wherein each of the PDCP count values is composed of a Hyper Frame Number (HFN) and a PDCP Sequence Number (SN).

15. The apparatus according to claim 1, wherein the at least one processor is configured to, in response to receiving from a distributed unit of the radio access network node a UE CONTEXT SETUP RESPONSE message containing a cell group configuration generated using full configuration, send the control message to the central unit user plane.

16. The apparatus according to claim 15, wherein the at least one processor is configured to include, in the control message, downlink transport network layer address information received from the distributed unit via the UE CONTEXT SETUP RESPONSE message and for a user plane interface between the distributed unit and the central unit user plane.

17. An apparatus configured to operate as a central unit user plane of a radio access network node, the apparatus comprising:
at least one memory; and
at least one processor coupled to the at least one memory and configured to:
receive from a central unit control plane of a radio access network node a single control message indicating that one or more Packet Data Convergence Protocol (PDCP) count values for an Acknowledged Mode (AM) data radio bearer (DRB) already configured for a radio terminal need to be reset.

18. The apparatus according to claim 17, wherein the at least one processor is configured to reset the one or more PDCP count values for the AM DRB in response to receiving the control message.

19. The apparatus according to claim 17, wherein
the central unit control plane is a gNB Central Unit Control Plane (CU-CP), and
the central unit user plane is a gNB Central Unit User Plane (CU-UP).

20-30. (canceled)

31. A method performed by a central unit control plane of a radio access network node, the method comprising:
sending to a central unit user plane of the radio access network node a single control message indicating that one or more Packet Data Convergence Protocol (PDCP) count values for an Acknowledged Mode (AM) data radio bearer (DRB) already configured for a radio terminal need to be reset.

32-34. (canceled)
